(19) United States
(12) Patent Application Publication
(10) Pub. No.: US 2007/0030623 A1
(43) Pub. Date: Feb. 8, 2007

(54) Organic capacitor having a voltage-controlled capacitance

(75) Inventors: Wolfgang Clemens, Puschendorf (DE); Dietmar Zipperer, Erlangen (DE)

Correspondence Address: CARELLA, BYRNE, BAIN, GILFILLAN, CECCHI,;STEWART & OLSTEIN, 5 BECKER FARM ROAD, ROSELAND, NJ, 07068, US

(73) Assignee: POLYIC GMBH & CO. KG, Erlangen (DE)

(21) Appl. No.: 10/568,730

(22) PCT Filed: Aug. 11, 2004
(86) PCT No.: PCT/DE04/01797

§ 371 Date: Feb. 17, 2006

(30) Foreign Application Priority Data
Aug. 20, 2003 (DE) 103 38 277.1

(51) Int. Cl. H01G 7/06; H01G 7/00

(52) U.S. Cl. 361/281

(57) ABSTRACT

The present invention relates to an organic capacitor having a voltage-controlled variable capacitance. The capacitor of the invention comprises at least one first electrode, a second electrode, and an interposed insulator layer and is characterized by at least one first semiconductor layer disposed between the first electrode and the second electrode. Between the first and second electrodes there is applied a voltage which acts on the semiconductor layer such that at least one concentration of free charge carriers in this at least first semiconducting layer is varied in a controlled manner by the applied voltage. The concentration of the charge carriers defines the capacitance of the capacitor.

The present invention relates to the field of organic capacitors, particularly capacitors which are based on organic materials and the capacitance of which is voltage-controlled.

Capacitors are among the traditional components of electrical circuits. Resonant electrical circuits comprising coils and capacitors, such as oscillating circuits for example, are tuned by dimensioning the component characteristics to one or more resonance frequencies. It is advantageous with respect to tuning such circuits, ie, resonant circuits, if tuning of the resonance frequencies can occur by electrical means, ie, in a voltage-controlled fashion. Organic circuits, particularly those based on polymers, are especially well-suited to applications such as radio transponders (RFID transponders, RFID tags) or radio-based anti-theft devices, because said circuits are extremely simple and are inexpensive to produce. The inductive antennas of such transponder systems are tuned to their resonance frequency by connecting a capacitor in parallel with the antenna. Once completed, the tuning cannot be readjusted or changed in the event of fluctuations in the nominal values of the components, which are generally production-related and can be avoided only at considerable expense or not at all.

It is therefore an object of the present invention to provide an organic capacitor whose capacitance is voltage-controlled. Such a voltage-controlled capacitor makes possible continuous, that is to say corrective, fine tuning, so that, for instance in an oscillating circuit, the desired resonance frequency can be maintained.

The object of the invention is achieved by an organic capacitor having at least one semiconductor layer, as is defined in the main claim 1. Advantageous embodiments and developments are defined in the subclaims.

According to a first aspect of the invention, an organic capacitor having a voltage-controlled capacitance is provided. The capacitor of the invention comprises at least one first electrode, one second electrode, and one interposed insulator layer, and is further characterized by at least one semiconductor layer which is disposed between the first and second electrodes. A voltage is applied between the first and second electrodes, and this influences the semiconductor layer so that a concentration of free charge carriers in this first semiconductor layer is varied controllably on the basis of the voltage applied. The concentration of the charge carriers defines the capacitance of the capacitor.

It is advantageous when not only the voltage applied, but also the frequency of the alternating voltage, determines the concentration of the free charge carriers in at least the first semiconductor layer. The frequency thus makes possible controlled variation of the concentration and consequently of the capacitance of the capacitor of the invention. This effect normally acts to reduce the charge carrier concentration as the frequency increases. The semiconductor thus acts as an insulator at very high frequencies (in the MHz or GHz range). Accordingly, at very high frequencies it is possible to conceive a capacitor which contains only an organic semiconductor between the electrodes but no additional insulator. However, in that case a leakage current flows at lower frequencies. This leakage current can be reduced by an appropriate choice of electrode materials via the work function.

It is advantageous when the variation of the concentration of the free charge carriers effectuates a variation of the effective spacing between the first and second electrodes, which act as the capacitor plates. The variation of the effective spacing determines the capacitance of the capacitor of the invention according to a functional relationship.

In addition, the variation of the concentration of the free charge carriers causes variation of an effective plate surface area. From a functional standpoint, the effective plate surface area also determines the capacitance of the capacitor of the invention.

Preferably at least one of the first and second electrodes is a first and/or second structured electrode, or both of the first and second electrodes can be a first and second structured electrode. At least one of the first and second structured electrodes is preferably embedded in the at least one semiconductor layer.

According to one embodiment of the invention, the organic capacitor of the invention comprises a second semiconductor layer interposed between the first and second electrodes. The first semiconductor layer and the second semiconductor layer are disposed on opposite sides of the insulator layer. A concentration of free charge carriers in the second semiconductor layer is controllably varied in a similar manner on the basis of the voltage applied between the first and second electrodes.

It is advantageous when the first and second semiconductor layers are of opposite conductivity types; ie, if the first semiconductor layer is a p-conductive layer, the second semiconductor layer will be an n-conductive layer, and if the first semiconductor layer is an n-conductive layer, then the second semiconductor layer will be a p-conductive layer. Of course, the two semiconductor layers can alternatively have the same conductivity characteristics. Equally advantageous is a structure in which the semiconductor layers are ambipolar, ie, both n- and p-conductive, which can be ensured by blending different materials.

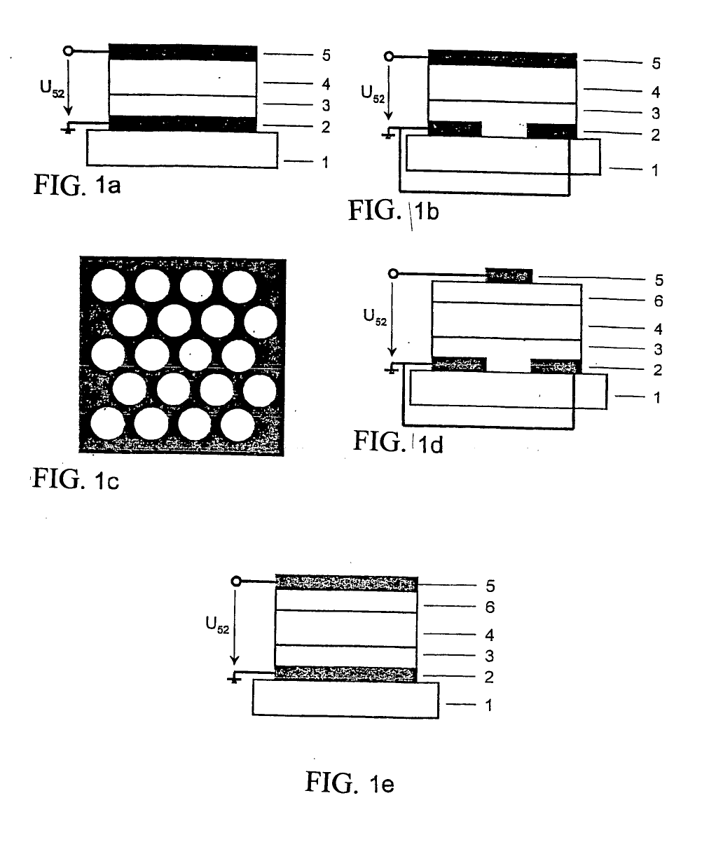

An equally advantageous configuration results from reversing the isolating and semiconducting layers, ie, with the semiconductor (No. 4) in the middle and the insulator above and below (No. 3, 6), as in FIG. 1e.

Preferably, at least one or both of the first and second structured electrodes are embedded in at least one or both of the first and second semiconductor layers respectively.

It is advantageous when at least one of the functional layers of the capacitor of the invention is an organic functional layer.

The term “organic materials” encompasses all types of organic, organometallic, and/or inorganic plastics materials except traditional semiconductor materials based on germanium, silicon, etc. The term “organic material” is not limited to carbon-containing material, but rather can also include materials such as silicones. Furthermore, in addition to polymeric and oligomeric substances, use can be made of “small molecules”. For the purposes of this invention, the implicit understanding is that organic layers are likewise obtained from these layer-forming materials and substances. Furthermore, for the purposes of the invention, organic structural components composed of different functional components are characterized by at least one organic functional component, in particular an organic layer.

Details and preferred embodiments of the subject matter of the invention are discernable from the dependent claims and the drawings with reference to which exemplifying embodiments will now be described in detail for the purpose of clarifying the subject matter of the invention, in which drawings:

FIG. 1a is a diagrammatic representation of a capacitor according to a first embodiment of the invention;

FIG. 1b is a diagrammatic representation of a capacitor according to a second embodiment of the invention;

FIG. 1c is a diagrammatic representation of a structured electrode layer of a capacitor according to a second embodiment of the invention;

FIG. 1d is a diagrammatic representation of a capacitor according to the third embodiment of the invention;

FIG. 1e is a diagrammatic representation of a capacitor according to the eleventh embodiment of the invention;

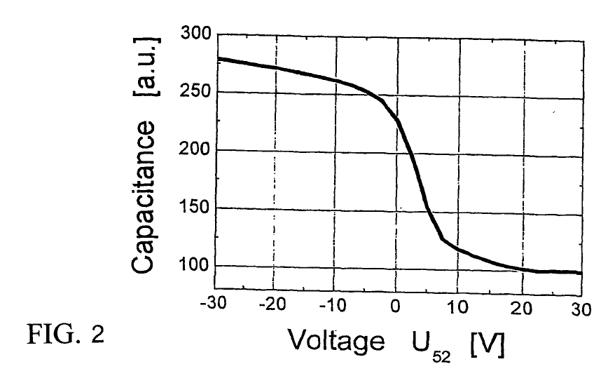

FIG. 2 is a graph showing the voltage-dependent capacitance of a capacitor of the invention;

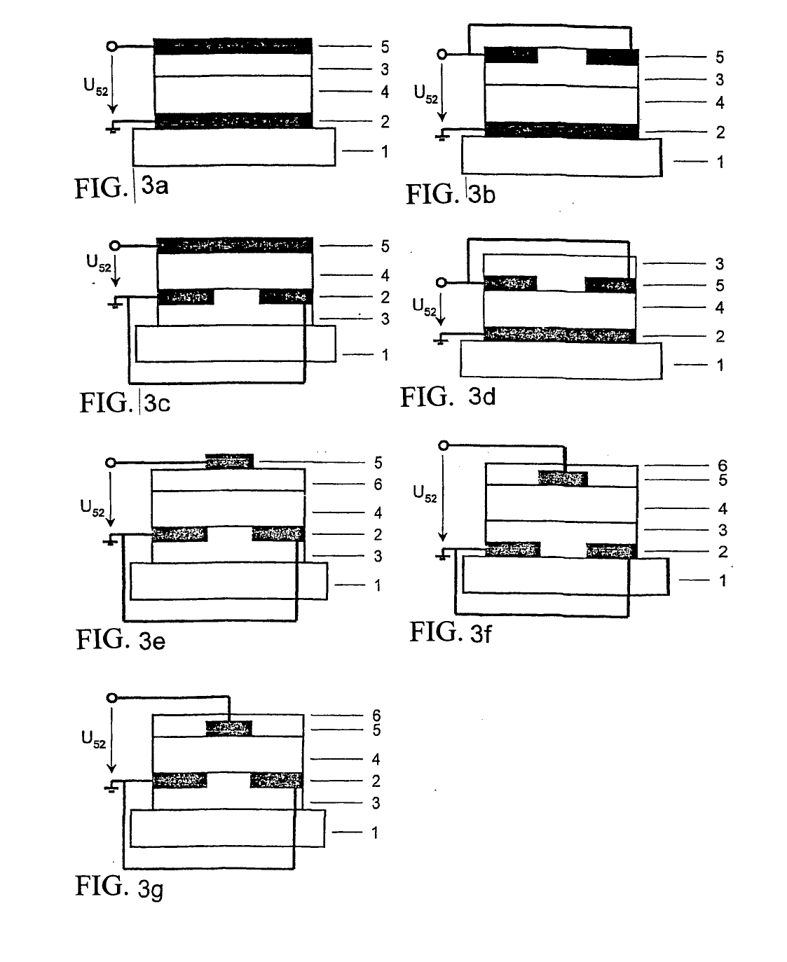

FIG. 3a is a diagrammatic representation of a capacitor according to a fourth embodiment of the invention;

FIG. 3b is a diagrammatic representation of a capacitor according to a fifth embodiment of the invention;

FIG. 3c is a diagrammatic representation of a capacitor according to a sixth embodiment of the invention;

FIG. 3d is a diagrammatic representation of a capacitor according to a seventh embodiment of the invention;

FIG. 3e is a diagrammatic representation of a capacitor according to an eighth embodiment of the invention;

FIG. 3f is a diagrammatic representation of a capacitor according to a ninth embodiment of the invention;

FIG. 3g is a diagrammatic representation of a capacitor according to a tenth embodiment of the invention; and

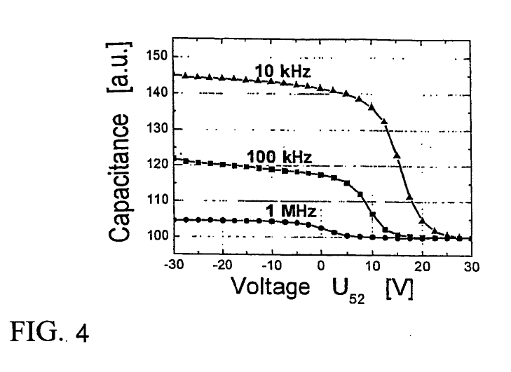

FIG. 4 is a graph depicting the voltage-dependent capacitance of a capacitor of the invention.

Identical and similar parts, elements, components, etc. are assigned the same reference characters throughout the figures.

FIG. 1a is a diagrammatic representation of a capacitor according to a first embodiment of the invention. The capacitor of the invention comprises a substrate 1, the support for the capacitor, that is to say for the functional layers of the capacitor. Deposited on the substrate 1 is a bottom (first) electrode 2, which is covered by a semiconductor layer 3. In turn, the semiconductor layer 3 supports an insulator layer 4, on which a top (second) electrode is superposed.

The substrate 1 can be a flexible polyester film, for example, which supports the bottom electrode 2.

Both the bottom (first) electrode 2 and the top (second) electrode 5 can be constructed as organic conductors, eg, PANI, PEDOT, polypyrrole, or carbon black electrodes. Alternatively, a bottom or top electrode 2, 5 can consist of a metallic conductor, eg, gold, copper, silver, aluminum, nickel, or chromium, or alloys of metal or other conductive particles (eg graphite or carbon black) which are present as particles in appropriate formulations or are colloidally bound therein and can be applied by suitable methods. Examples thereof include conductive silver and carbon black.

The organic semiconductor layer 3 can be fabricated from conjugated polymers in an n-type or p-type modification, for instance polythiophene, polyfluorene, or from small molecules in an n-type or p-type modification, for instance pentacene, naphthacene, or C60.

The insulator layer 4 can be provided in the form of an organic insulator layer 4 which can be produced from, say, polyisobutylene, polystyrene, poly(4-hydroxystyrene), polymethyl methacrylate, polyvinylidene fluoride, or cymel. The insulator layer can alternatively be produced by means of surface modification of the electrodes, eg, by oxidation of metal electrodes as is known particularly in the case of aluminum, or by surface modification of organic conductors, which gives them insulating or poorly conducting surface characteristics.

In contrast to the organic capacitors of the prior art, which, as described above, cannot be varied by the voltage, the capacitor of the invention comprises an additional semiconductor layer 3, which causes the capacitance to be dependent on the voltage. The critical parameter for the voltage dependency resulting from the invention is the concentration of free charge carriers in the semiconductor layer 3 which results from the application of a voltage U₅₂ between the bottom (first) electrode 2 and the top (second) electrode 5. With varying voltage U₅₂, the concentration of the free charge carriers in the semiconductor layer 3 varies. The variation of the free charge carriers is referred to as the enhancement or depletion of the semiconductor layer 3. In the enhanced state there are many charge carriers in the semiconductor layer 3, ie, the concentration is high. On the other hand, in the depleted state there are no more free charge carriers in the semiconductor layer, ie, the concentration is low or minimal.

The effective spacing between the two capacitor plates is a critical factor determining a capacitor's capacitance, and in this case it is the distance between the bottom (first) electrode 2 and the top (second) electrode 5. Considering the variation of the free charge carriers by means of the applied voltage U₅₂ as described above, the effective spacing a of the two electrodes varies between a spacing aₘᵢₙ=dₘ in the enhanced state, which corresponds to a thickness dm of the insulator layer 4, and a spacing aₘₐₓ=d_{sc}+dₘ in the depleted state, which is equal to the sum of the thickness d_{sc} of semiconductor layer 3 and the thickness dₘ of the insulator layer 4.

Accordingly, the capacitance of the component, which is substantially functionally proportional to the effective plate spacing a, is high in the enhanced state and low in the depleted state. The construction of a voltage-dependent organic capacitor according to the first embodiment of the invention, as represented in FIG. 1a, makes it possible to vary the capacitance of the capacitor of the invention by a factor of from 2 to 3.

FIG. 1b is a diagrammatic representation of a capacitor according to the second embodiment of the invention.

The above described variation of the capacitance can be facilitated by appropriately structuring the bottom electrode 2. FIG. 1b indicates a possible way of structuring the bottom electrode 2. The structure relates to the effective surface area of the bottom electrode 2 serving as a capacitor plate.

In addition to the variation of the effective plate spacing a of the capacitor, there occurs, in the depleted state of semiconductor layer 3, a reduction of the effective plate surface area of the capacitor to the surface area of the structured bottom electrode 2′, which is smaller than the plate surface area of the top electrode 5 serving as the second capacitor plate.

When the semiconductor layer 3 is in the enhanced state, this top electrode 5 determines the effective plate surface area. That is to say, the thickness dm of the insulator layer 4 similarly determines the capacitance of the capacitor of the invention.

By optimally structuring the bottom electrode 2, the capacitance of the capacitor of the invention can be further varied by an additional factor of 10 over and above the variation based on the effective spacing a. FIG. 1c is a diagrammatic view of an optimally structured electrode layer 2′ of a capacitor according to a second embodiment of the invention. The effective plate surface area of this electrode layer 2 is reduced by the total surface area of the circular recesses (which are represented by white circular structures) in the bottom electrode 2.

FIG. 2 illustrates a typical qualitative curve of a voltage-dependent capacitance of a capacitor of the invention. The capacitance is plotted in arbitrary units against the voltage U₅₂ applied between the bottom and top electrodes 2, 5. In particular, the curve of the voltage-dependent capacitance represents the curve for a voltage-controlled variable-capacitance capacitor including an intrinsic semiconductor 3 with hole conduction such as polythiophene. Positive voltages U₅₂ will cause the semiconductor layer 3 to be in the depleted state, ie, the capacitor will exhibit a low capacitance, whereas negative voltages U₅₂ will cause it to assume the enhanced state, ie, the capacitor will exhibit a high capacitance. In this case, the capacitance variation between the depleted and enhanced states is 100 to 275 (ie a variation by a factor of 2.75), given an applied voltage U₅₂ in the range of ±30 V.

In the embodiments of FIGS. 1a and 1b the fundamental principle of the invention has been described above with reference to the example of two embodiments of the capacitor having a voltage-controlled capacitance. The following embodiments represent further advantageous developments of the capacitor of the invention, which are based substantially on the principles described above.

FIG. 1e is a diagrammatic representation of a capacitor according to the eleventh embodiment of the invention. According to this embodiment, the variation of the voltage-controlled capacitance of the capacitor of the invention can be increased by adding a second semiconductor layer 6. Its conductivity type must be the opposite of that of the first semiconductor layer, ie, if semiconductor layer 3 is p-conductive, then semiconductor layer 6 has to be n-conductive, and vice versa. In the enhanced state, both semiconductor layers 3 and 6 are filled with charge carriers, ie, the semiconductor layers 3 and 6 show a high concentration of free charge carriers. As a result, the capacitance is at a maximum, because the spacing between the semiconductor layers 3 and 6, which is determined by the thickness dₘ of the insulator layer, determines the effective plate spacing. In the depleted state, the two semiconductor layers 3 and 6 are depleted, ie, they no longer contain any free charge carriers. As a result, the capacitance is at a minimum, because the spacing between the electrodes 2 and 5, which is defined by the thickness dₘ of the insulator layer 4 and the thickness of the semiconductor layers 3 and 6, d_{SC3} and d_{SC6}, determines the effective plate spacing a. FIG. 1d is a diagrammatic representation of a capacitor according to the third embodiment of the invention. In this embodiment, allowance must be made, in the depleted state, for the fact that the effective plate surface area of the capacitor of the invention is influenced by the structure of the bottom (first) structured electrode 2′ and of the top (second) structured electrode 5′. If the structured electrodes 2′ and 5′ are disposed at an offset relative to one another, as illustrated in FIG. 1d, the capacitance in the depleted state can disappear almost completely, because there are substantially no opposing conductive capacitor plates, and therefore the effective plate surface area is minimal.

Alternatively to the configuration of the capacitor of the invention described above, it is possible to partly reverse the configuration of the functional layers without sacrificing the described effect—the voltage-dependent capacitance. FIG. 3 and FIG. 4 represent diagrammatically a fourth and fifth embodiment of a capacitor of the invention, respectively, which are substantially analogous to the embodiments represented in FIG. 1a and FIG. 1b respectively.

Referring to FIG. 3a, this shows an example of how a capacitor of the invention can be realized by depositing the insulator layer 4 on the bottom (first) electrode 2 supported by the substrate 1, depositing the semiconductor layer 3 on the insulator layer 4, and covering the semiconductor layer 3 with the top (second) electrode. Experts on organic components will recognize that this technique results in a capacitor with a voltage-controlled variable capacitance.

The capacitor of the invention according to the embodiment represented in FIG. 3b comprises a structured top (second) electrode 5′ and a general structure similar to the capacitor of the invention represented in FIG. 3a. It is apparent that this capacitor has analogously the advantages and the behavior of the capacitor described in FIG. 1b.

Alternatively to the above described embodiments (illustrated in FIG. 1b and FIG. 3b), it is equally possible to provide a layer structure in which only that variation effect is realized which derives from the plate surface areas as are varied in the enhanced and depleted states of the semiconductor layer(s) 3, 5. Corresponding capacitors according to further embodiments of the invention are illustrated in FIG. 3c and FIG. 3d.

According to FIG. 3c, the semiconductor layer 3 is deposited on the substrate 1, and the bottom (first) structured electrode 2′ is embedded in the semiconductor layer 3 such that it is in contact with the insulator layer 4 which covers the semiconductor 3 and the bottom (first) structured electrode 2′. The top (second) unstructured electrode 5′ is deposited on the insulator layer 4.

According to FIG. 3d, the substrate 1 supports the bottom (first) unstructured electrode 2′, which is covered by the insulator layer 4, which is in contact with the top (second) structured electrode 5′ and the semiconductor layer 3 in which the top (second) electrode is embedded.

Regarded in the context of the teaching of the present invention and in the light of its principles as described above, the person skilled in the art will recognize that in both the depleted and the enhanced states of the semiconductor layer 3 the effective spacing a of the embodiments of the capacitors of the invention represented in FIG. 3c and FIG. 3d is equal to the thickness dm of the insulator layer 4. The variation of the capacitance is determined by the variation of the effective plate surface area.

In the embodiment of the capacitor of the invention represented in FIG. 3c, the effective plate surface area in the enhanced state of the semiconductor layer 3 is determined by the total surface area adjacent to the insulator layer 4, which is defined by the surface area of the bottom (first) structured electrode 2′ adjacent to the insulator layer 4 and the surface area of semiconductor layer 3 adjacent to the insulator layer 4. By contrast, the effective plate surface area in the depleted state of the semiconductor layer 3 is determined substantially by the surface area of the bottom (first) structured electrode 2′ adjacent to the insulator layer 4.

The same applies to the embodiment of the capacitor of the invention represented in FIG. 3c. Here, the effective plate surface area in the depleted state of the semiconductor layer 3 is determined by the surface area of the top (second) structured electrode 5 adjacent to the insulator layer 2, whereas the effective plate surface area in the enhanced state of the semiconductor layer 3 is determined by the total surface area adjacent to the insulator layer 4, which is defined by the surface area of the top (second) structured electrode 5 adjacent to the insulator layer 4 and the surface area of semiconductor layer 3 adjacent to the insulator layer 4.

Further embodiments of the capacitor of the invention which are based on the variation effect of the effective plate surface areas can be derived from the embodiment described with reference to FIG. 1d. Here, at least one of the two structured electrodes, namely the bottom (first) structured electrode 2′ and the top (second) structured electrode 5′, is provided adjacent to the insulator layer 4 and suitably embedded in one of the semiconductor layers 3 and/or 6.

In detail, FIG. 3e represents a capacitor of the invention which is supported by a substrate 1, there being deposited on said substrate a semiconductor layer 3 in which the bottom (first) structured electrode 2′ is embedded such that both the first semiconductor layer 3 and the bottom (first) structured electrode 2′ are adjacent to a covering insulator layer 4. Further provided on the insulator layer 4 is a second semiconductor layer 6, which in turn supports a top (second) structured electrode 5′.

FIG. 3f shows a capacitor of the invention consisting of a first (bottom) structured electrode 2′ which is deposited on a substrate 1 and embedded in a first semiconductor layer 3 that is adjacent to, and covered by, an insulator layer 4. Furthermore, there is provided on the insulator layer 4 a top (second) structured electrode 5′ which is embedded in a second semiconductor layer 6. Both the electrode and the semiconductor layer are adjacent to the insulator layer.

FIG. 3g represents a capacitor of the invention which, as in FIG. 3e, provides a bottom (first) structured electrode 2′ which is embedded in a first semiconductor layer 3 on a substrate 1 such that both the bottom (first) structured electrode 2′ and the first semiconductor layer 3 are adjacent to an insulator layer 4 covering the latter. As in FIG. 3f, a top (second) structured electrode 5′ and a second semiconductor layer 6 are both adjacent to the insulator layer 4, the top (second) structured electrode 5′ being embedded in the second semiconductor layer 6.

The critical determinant of the capacities of the capacitor of the invention of the embodiments represented in FIGS. 3e to 3f in the depleted state of the first semiconductor layer 3 and the second semiconductor layer 6 is the spacing between the bottom (first) structured electrode 2′ and the top (second) structured electrode 5′ allowing for the effective plate surface areas, which effective plate surface areas are influenced by the structure of the bottom (first) structured electrode 2′ and that of the top (second) structured electrode 5′. Depending on the construction of the bottom (first) structured electrode 2′ and the top (second) structured electrode 5′, the effective plate surface area substantially determines the capacitance.

As explained with reference to FIG. 1d, in the embodiments described above, the capacities in the depleted state can substantially disappear if the electrodes 2′ and 5′ are disposed at an offset relative to one another or structured as illustrated in FIG. 1d and FIGS. 3e to 3g, respectively, because there are substantially no opposing conductive capacitor plates.

In the enhanced state of the first semiconductor layer 3 and of the second semiconductor layer 6, the effective plate surface areas are determined by the areas of the semiconductor layers 3 or 6 adjacent to the insulator layer 4, or by the total area of the semiconductor layers 3 or 6 adjacent to the insulator layers 4 plus the embedded bottom or top structured electrodes 2 or 5. Hence the capacities are substantially determined by the thickness dm of the insulator layers 4.

It should also be noted that the semiconductor layers 3 and 6 are to be of opposite conductivity types in order to make the above described behavior of the capacities possible. This means that if the semiconductor layer 3 is p-conductive, the semiconductor layer 6 is to be n-conductive, and vice versa.

The capacitance of a capacitor of the invention in relation to the voltage U₅₂ applied between the bottom (first) electrode 2 or 2′ and the top (second) electrode 5 or 5′ respectively has been described above with reference to FIG. 2 for a given frequency.

The capacitance variation is frequency dependent owing to the characteristics of semiconductor layer 3, or semiconductor layers 3 and 6, respectively, which are switched to a depleted or enhanced state by the voltage U₅₂, ie, the concentration of free charge carriers therein is varied by the voltage U₅₂ such that the semiconductor layers exhibit variable conductivity. The frequency dependency is substantially determined by the rate of variation of the concentration of free charge carriers in response to a varying voltage U₅₂ applied thereto. The direct result is that, given a constant rate of change of the concentration, as the frequency of the voltage rises, the variation of the capacitance for the same voltage range of the voltage U₅₂ decreases.

FIG. 4 is a graph showing the frequency-dependent and voltage-dependent capacitance of a capacitor of the invention. It is apparent that, as the frequency rises, the capacitance variation decreases when the voltage U₅₂ varies in the same voltage range ±30 V. In the example shown, the capacitance variation decreases from approx. 100:145 at a frequency of approx. 10 kHz to approx. 100:122 at a frequency of approx. 100 kHz, then to approx. 100:105 at a frequency of approx. 1 MHz. This kind of frequency dependent behavior is advantageous particularly for the (fine) adjustment of resonant circuits in which the frequency dependent capacitor is connected parallel to an inductance.

The fabrication of the [layers] for a capacitor according to an embodiment of the invention can be performed in a conventional fashion, the individual layers being fabricated by known methods such as sputtering or evaporation, spin coating or printing, provided the substances of the functional layers that are deposited are soluble. A structuring of the functional layers such as may be required in connection with the utilization of structured electrodes 2′ and 5′ can be performed either by conventional techniques like etching and lift-off in conjunction with lithographic methods, or by various printing techniques. The individual functional layers are typically less than 2 μm thick.

The embodiments of a capacitor of the invention having a voltage-controlled variable capacitance which are represented in FIG. 1a and FIG. 1b can be fabricated in the following way, for example. A bottom (first) electrode 2 in the form of a metal layer, eg, a gold layer, is sputtered onto a flexible polyester film serving as the substrate 1. The gold layer can be structured by a lithographic technique or by etching in order to obtain a bottom (first) structured electrode 2′ according to FIGS. 1b and 1c. Next, a conjugated polymer in solution, eg, polythiophene, is applied by spin coating. When the solvent has evaporated, there is formed a homogenous semiconductor layer, semiconductor layer 3. The insulating layer, ie, insulator layer 4, is similarly applied from, say, a polyhydroxystyrene (PHS) solution, using spin coating, such that when the solvent has evaporated there is formed a homogenous insulating layer 4. On this layer there is deposited a top (second) electrode 5 in the form of a metal layer, particularly a gold layer, which can again be structured using lithographic or etching methods.

The construction of the voltage-controlled organic capacitor of one of the embodiments of the present invention and particularly those described with reference to FIG. 1a and FIG. 1b from conductive, semi-conductive, and insulating functional layers is substantially compatible with well-established processing steps for the production of integrated organic circuits or polymer circuits. As a result, it is possible to integrate a capacitor of the invention having a voltage-controlled variable capacitance into such an organic circuit.

For example, a capacitor of the invention having a voltage-controlled variable capacitance can be used in conjunction with diodes as a rectifier, as an RC element, in a resonant circuit as a frequency dependent capacitor, as a smoothing capacitor, as a thin-film component, etc. For the latter application, the thickness of the functional layers can be less than 2 μm. In this way, the capacitor of the invention is suitable for integration into radio transponders (RFID transponders, RFID tags) or anti-theft labels. Combinations in other applications are also conceivable, for instance transistors, diodes, LEDs, photovoltaic cells, or photodetectors, or with flat batteries or electrochrome elements, particularly if these components are also based on organic functional layers.

1. An organic capacitor having voltage-controlled capacitance, comprising at least the following functional layers:
a first electrode, a second electrode, and
an insulator layer disposed between the first and second electrodes, wherein
at least one first semiconductor layer is located between the first and second electrodes, and wherein
the concentration of free charge carriers in at least said first semiconductor layer is varied in a controlled manner by application of a voltage between said first and second electrodes,
the concentration of said charge carriers determining the capacitance of the capacitor, and
the concentration of said free charge carriers in at least said first semiconductor layer is additionally varied in a controlled manner by a frequency of the applied voltage.

2. An organic capacitor as defined in claim 1, wherein the variation of the concentration of said free charge carriers results in a variation of an effective spacing (a) of the electrodes serving as capacitor plates, and said effective spacing (a) functionally determines the capacitance.

3. An organic capacitor as defined in claim 2 wherein the variation of the concentration of said free charge carriers results in a variation of an effective plate surface area, and said effective plate surface area functionally determines the capacitance.

4. An organic capacitor as defined in claim 1 wherein at least one of said first and second electrodes is a structured electrode.

5. An organic capacitor as defined in claim 4 wherein the at least one of said first structured electrodes is embedded in said semiconducting layer.

6. An organic capacitor as defined in claim 1 wherein said organic capacitor comprises a second semiconductor layer located between said first and second electrodes and disposed on one of the sides of said insulator layer opposite said first semiconductor layer, the concentration of said free charge carriers in said second semiconductor layer being varied in a controlled manner by applying a voltage between said first and second electrodes.

7. An organic capacitor as defined in claim 6, wherein said first and second semiconducting layers are of opposed conductance types.

8. An organic capacitor as defined in claim 6, wherein at least one of said first and second electrodes is a structured electrode and the at least one structured electrodes is embedded in at least one of said first and second semiconductor layers.

9. An organic capacitor as defined in claim 1 wherein at least one of said functional layers is a layer of an organic substance.
